(19) United States
(12) Patent Application Publication
(10) Pub. No.: US 2025/0057706 A1
(43) Pub. Date: Feb. 20, 2025

(54) MODULAR RAMP WITH COLLAPSIBLE SIDE RAIL AND LIGHTING

(71) Applicant: The Braun Corporation, Winamac, IN (US)

(72) Inventors: Adam Wojdyla, Winamac, IN (US); Michael Pugh, Carmel, IN (US); Andrew Henseleit, Noblesville, IN (US)

(21) Appl. No.: 18/805,610

(22) Filed: Aug. 15, 2024

Related U.S. Application Data
(60) Provisional application No. 63/520,393, filed on Aug. 18, 2023.

(51) Int. Cl. A61G 3/06

(52) U.S. Cl. CPC A61G 3/061

(57) ABSTRACT

A ramp assembly for a passenger vehicle for transporting one or more passengers. The ramp assembly accommodates ingress and egress of a physically limited passenger and includes one or more of a collapsible siderail, a modular construction, and/or lighting. The ramp assembly includes a platform base having a first platform side assembly coupled to a first side of the base. The first platform side assembly includes a first track section located on a top side of the first platform side assembly, a first collapsible siderail, and a first light mounting structure to support an illumination device. A second platform side assembly is coupled to a second side of the base. The second platform side assembly includes a second track section located on a top side of the second platform side assembly, a second collapsible siderail, and a second light mounting structure to support an illumination device.

### CROSS REFERENCE TO OTHER APPLICATIONS

This application claims priority to U.S. Provisional Patent Application Ser. No. 63/520,393, filed on Aug. 18, 2023, the contents of which are incorporated herein by reference. This application also incorporates by reference the contents of PCT Application Serial No. PCT/US24/42237, filed on Aug. 14, 2024.

### FIELD OF THE DISCLOSURE

The present application relates to a passenger vehicle for transporting one or more passengers and, more particularly, to a ramp assembly for accommodating ingress and egress of a physically limited passenger, where the ramp assembly may include a collapsible side rail, a modular construction, and/or lighting.

### BACKGROUND

Automobile manufacturers do not currently mass-produce passenger vehicles specifically designed to transport passengers having mobility disabilities, either as a driver or a passenger. It is anticipated that the same will be true for future (possibly driverless) autonomous vehicles (AVs), including those intended for the ride-sharing market. Consequently, mass-produced passenger vehicles are and will continue in the future to be modified, or retrofitted, by aftermarket companies dedicated to supplying vehicles to passengers with mobility disabilities. Such vehicles can be modified by removing certain parts or structures within a vehicle and replacing those parts with parts specifically designed to accommodate the passenger's unique conditions. For example, in one configuration, a vehicle may be retrofitted with a ramp to enable a physically limited individual using a wheelchair to enter the vehicle without the assistance of another individual. Once inside the vehicle, such individuals may operate the vehicle as a vehicle operator or occupy locations designated for passengers. This may include, but is not limited to, a front passenger location or mid and rear passenger locations.

In some vehicles, which are considered viable candidates for retrofitting, the construction of the vehicle requires significant modification to accommodate the addition of a ramp and provide adequate headroom for a passenger seated in a wheelchair. For example, in one or more modifications of a minivan, at least a portion of the OEM floor will be removed and replaced with a new, lower floor (sometimes referred to as a floor weldment or floor structure). A fold-up, above-floor ramp may be installed on top of the new floor surface of the floor weldment, or the floor weldment may include a recessed area for receiving an in-floor ramp whereby the top cover of the in-floor ramp will be approximately flush with the new floor surface of the floor weldment. In some cases, the vehicle body must also be raised to maintain adequate ground clearance. In-floor ramps allow for unimpeded ambulatory access to the vehicle with the ramp in a stowed position but usually require a greater vehicle body raise than is required by ramps of other types, such as folding, above-floor ramps.

It is anticipated that future AVs will be electric vehicles with large, high voltage batteries located in the vehicle floor, which will at least complicate and possibly prevent the removal and replacement of the floor with a weldment having a lowered floor. Accordingly, a vehicle already having sufficient headroom to accommodate a passenger seated in a wheelchair may be considered a more viable candidate for conversion. In these cases, it is contemplated herein that a false floor can be installed above the OEM floor to define a pocket or recessed area aligned with a door opening for receiving an in-floor ramp. In some embodiments, the false floor can include a panel covering the in-floor ramp. In other embodiments, a top cover of the in-floor ramp may be approximately flush with the new false floor surface.

### SUMMARY OF THE EMBODIMENTS

In one embodiment, there is provided a ramp assembly to accommodate a wheelchair passenger to enter or exit a motorized vehicle. The ramp assembly include a ramp platform defined by a platform base having a first side and a second side, a first platform side assembly removably coupled to the first side, and a second platform side assembly removably coupled to the second side.

In some embodiments, the first platform side assembly includes a first track section located on a top side of the first platform side assembly and a first roller track located on a bottom side of the first platform side assembly beneath the first track section. Additionally, The second platform side assembly including a second track section located on a top side of the second platform side assembly and a second roller track located on a bottom side of the first platform side assembly beneath the second track section.

In some embodiments, the first platform side assembly includes at least one support structure to provide a beam strength to the ramp assembly.

In some embodiments, the at least one support structure defines a tube.

In some embodiments, the first platform side assembly includes a first bottom support structure and a second bottom support structure spaced from the first bottom support structure, wherein the first roller track is located between the first bottom support structure and the second bottom support structure.

In some embodiments, the second platform side assembly includes a third bottom support structure and a fourth bottom support structure spaced from the third bottom support structure, wherein the second roller track is located between the third bottom support structure and the fourth bottom support structure.

In some embodiments, one or more of the first bottom support structure, the second bottom support structure, the third bottom support structure, and the fourth bottom support structure define a channel.

In some embodiments, the first bottom support structure includes a first sidewall having a bottom portion and a top portion. Additionally, the first sidewall extends from the bottom portion beneath the first track section and extends to the top portion above the first track section.

In some embodiments, the top portion of the first sidewall defines a first slot with a first top sidewall, wherein the first slot is configured to receive a first siderail.

In some embodiments, the first siderail includes a first bar rotatably supported by a plurality of first legs, wherein each of the plurality of first the legs is rotatably coupled to the first sidewall and the first siderail includes a lowered position in the first slot and a raised position extended from the first slot.

In some embodiments, the third bottom support structure includes a third sidewall having a bottom portion and a top portion. Additionally, the third sidewall extends from the bottom portion beneath the second track section and extends to the top portion above the second track section.

In some embodiments, the top portion of the third sidewall defines a second slot with a second top sidewall, wherein the second slot is configured to receive a second siderail.

In some embodiments, the second siderail includes a second bar rotatably supported by a plurality of second legs, wherein each of the plurality of second legs is rotatably coupled to the third sidewall and the second siderail includes a lowered position in the second slot and a raised position extended from the second slot.

In some embodiments, one or both of the first platform side assembly or the second platform side assembly includes respectively an extruded first side part or an extruded second side part.

In some embodiments, the extruded first side part and extruded second side part are interchangeable.

In some embodiments, one or both of the first platform side assembly or the second side assembly includes respectively a first siderail assembly or a second siderail assembly.

In some embodiments, the first siderail assembly and second siderail assembly are interchangeable.

In some embodiments, there is provided a chassis pivotally coupled to a trailing edge of the ramp platform and movable along a length of a guide rail assembly

In some embodiments, the guide rail assembly is disposed between a left side and a right side of the ramp platform.

In some embodiments, the guide rail assembly is disposed below the ramp platform.

In some embodiments, two ramp assemblies are provided, including a first ramp assembly and a second ramp assembly. The platform base of the first ramp assembly has a different width than the platform base of the second ramp assembly. A first set of the first and second platform side assemblies are interchangeable with a second set of the first and second platform side assemblies.

In some embodiments, the first set of the first and second platform side assemblies are identical to the second set.

In some embodiments, the first bar comprises a channel and at least one of the first legs nests within the channel when the first siderail is in the lowered position.

In some embodiments, the first slot is defined by a pair of sidewalls and wherein the plurality of leg links are received between and pivotably secured to the pair of sidewalls.

In some embodiments, a top of the first siderail is disposed approximately at or below a top edge of the pair of sidewalls.

In another embodiment, there is provided a method of manufacturing the first and second ramp assemblies. The method includes removably coupling the first set of the first and second platform side assemblies to the platform base of one of the first ramp assembly and the second ramp assembly and removably coupling the second set of the first and second platform side assemblies to the platform base of the other of the first ramp assembly and the second ramp assembly.

In another embodiment, there is provided a method of repairing the ramp assembly. The method includes decoupling a damaged one of the first platform side assembly and the second side assembly and removably coupling a new one of the first platform side assembly and the second side assembly.

In another embodiment, there is provided a ramp assembly configured to move between a retracted position and an extended position to enable a wheelchair passenger to enter or exit a motorized vehicle. The ramp assembly includes a stationary catch assembly configured to be fixedly coupled to the motorized vehicle. The ramp assembly also includes a ramp platform having at least one siderail assembly with a plurality of leg links pivotally coupled between a siderail bar and the ramp platform. One of the plurality of leg links defines a control link being pivotally coupled at a first end to the siderail bar, pivotally coupled at a second end to a trigger link, and pivotally coupled between the first and the second end to the ramp platform. The trigger link includes an engagement member configured to be received and held stationary by the stationary catch assembly as the ramp assembly nears its extended position whereby the trigger link pivots the control link to move the siderail assembly from a collapsed position to a raised position as the ramp assembly continues moving toward its extended position.

In some embodiments, the plurality of leg links and the siderail bar define a parallelogram linkage.

In some embodiments, the second end of the control link is disposed below the ramp platform.

In some embodiments, a spring member biases the siderail assembly to the collapsed position.

In some embodiments, the spring member is connected between the ramp platform and the trigger link.

In some embodiments, the catch assembly includes at least one hook, wherein the engagement member of the trigger link engages the hook as the ramp assembly moves from the retracted position to the extended position.

In some embodiments, the ramp platform comprises a first platform side assembly and a second platform side assembly removeably coupled to opposite sides of a platform base, wherein each of the first platform side assembly and the second platform side assembly includes a predetermined width, and the platform base includes a selectable width selected to provide a ramp assembly having an overall ramp assembly width.

In some embodiments, one or both of the first platform side assembly and the second platform side assembly includes respectively an extruded first side part or an extruded second side part.

In some embodiments, the ramp platform includes at least one support structure providing a beam strength.

In some embodiments, the spring member is at least partially concealed within the support structure.

In some embodiments, the siderail bar comprises a channel and wherein at least one of the leg links nest within the channel when the siderail assembly is in the collapsed position.

In some embodiments, the ramp platform comprises a slot defined by a first sidewall and a second sidewall and wherein the plurality of leg links are received between and pivotably secured to the first sidewall and the second sidewall.

In some embodiments, a top of the siderail assembly is disposed approximately at or below a top edge of each of the first sidewall and the second sidewall.

In some embodiments, the siderail assembly is moveable in a generally normal direction relative to the ramp platform between the collapsed position and the raised position.

In some embodiments, when positioned in the extended position, the ramp platform is adapted to extend between a vehicle floor and a ground at a range of angles relative to the ground. Additionally, the siderail assembly has a nearly constant height within the entire range of angles.

In some embodiments, the engagement member defines a pivot axis for the trigger link when the engagement member is received and held stationary by the stationary catch.

In some embodiments, at least one roller supports an underside of the ramp platform in the extended position. The roller has a roller axis, wherein the roller axis is spaced from the pivot axis by a distance less than a radius of the roller.

In another embodiment, there is provided a ramp assembly to enable a wheelchair passenger to enter or exit a motorized vehicle. The ramp assembly includes a ramp platform having at least one sidewall extending upward therefrom, wherein the at least one sidewall includes a longitudinal track configured to receive an illumination device by insertion through an end of the track or by snapping or angling in a direction generally normal to the longitudinal track.

In some embodiments, the at least one sidewall and longitudinal track are integrally extruded.

In some embodiments, the illumination device is provided.

In some embodiments, the illumination device includes one or more of an incandescent light and an LED light.

In some embodiments, the illumination device is characterized by one or both of flashing indicators or color indicators.

In some embodiments, the illumination device is a light strip.

In another embodiment, there is provided a ramp assembly configured to move between a retracted position and an extended position to enable a wheelchair passenger to enter or exit a motorized vehicle. The ramp assembly includes a ramp platform having at least one siderail assembly. The siderail assembly has a plurality of leg links pivotally coupled between a siderail bar and the ramp platform. The siderail bar comprises a channel, wherein at least one of the leg links nest within the channel when the siderail assembly is in the collapsed position.

In another embodiment, there is provided a ramp assembly configured to move between a retracted position and an extended position to enable a wheelchair passenger to enter or exit a motorized vehicle. The ramp assembly includes a ramp platform havinging at least one siderail assembly with a plurality of leg links pivotally coupled between a siderail bar and the ramp platform. The ramp platform comprises a slot defined by a first sidewall and a second sidewall, wherein the plurality of leg links are received between and pivotably secured to the first sidewall and the second sidewall.

In some embodiments, a top of the siderail assembly is disposed approximately at or below a top edge of each of the first sidewall and the second sidewall.

In another embodiment, there is provided a ramp assembly configured to move between a retracted position and an extended position to enable a wheelchair passenger to enter or exit a motorized vehicle. The ramp assembly includes a ramp platform including at least one siderail assembly having a plurality of leg links pivotally coupled between a siderail bar and the ramp platform. The siderail assembly is moveable in a generally normal direction relative to the ramp platform from a collapsed position to a raised position as the ramp assembly moves from the retracted position to the extended position. When positioned in the extended position, the ramp platform is adapted to extend between a vehicle floor and a ground at a range of angles relative to the ground. The siderail assembly has a nearly constant height within the entire range of angles.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a passenger vehicle including an in-floor ramp assembly with a ramp platform in a deployed position.

FIG. 2 is a perspective view of one embodiment of a ramp assembly.

FIG. 3 is a top perspective view of a first side part which is included as a part of a platform side assembly.

FIG. 4 is a bottom perspective view of a first side part which is included as a part of a platform side assembly.

FIGS. 5A and 5B are perspective views of a platform side assembly.

FIG. 6 is a perspective view of a floor plate assembly.

FIGS. 7A and 7B are perspective side views of a side rail, a side rail linkage, and a T-bar assembly.

FIGS. 8A and 8B are elevational side views of a side rail, a side rail linkage, and a T-bar assembly.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

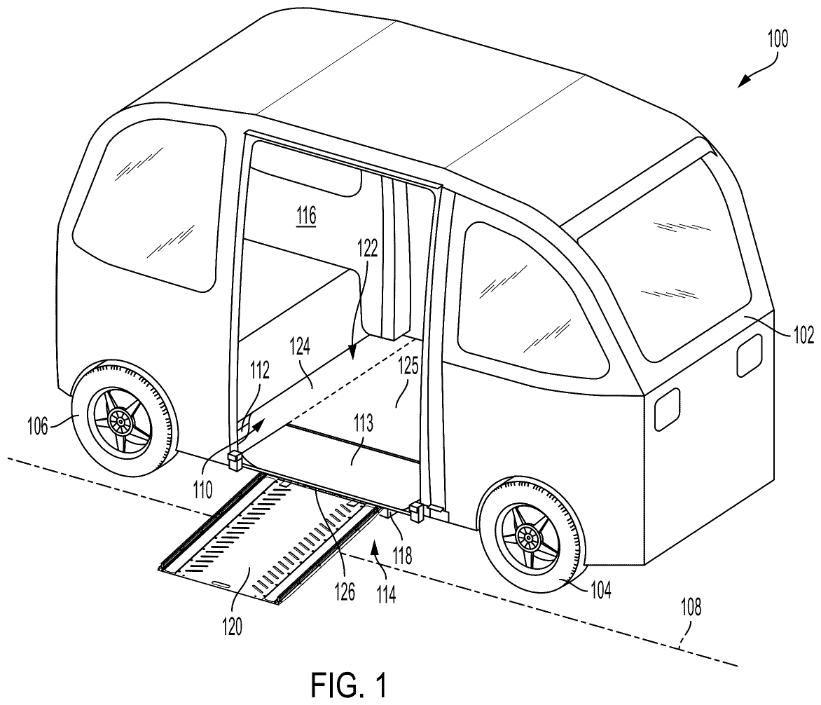

FIG. 1 illustrates an autonomous rideshare vehicle 100, similar to those being developed by a number of different United States and foreign manufacturers. The principles and teachings of the present disclosure may be used with this rideshare vehicle 100 or any type of vehicle. In the illustrative embodiment shown in FIG. 1, the vehicle 100 includes a unibody construction, but other vehicles having a frame on body construction are also included in the present disclosure. Consequently, the use of vehicle herein includes all types and kinds of vehicles with a body on frame construction, a unibody construction, or other constructions. In addition, while an autonomous rideshare vehicle 100 is illustrated in FIG. 1, the present disclosure is directed to all passenger vehicles carrying one or more passengers including, but not limited to, a bus, motor coach, sport-utility vehicle, truck, taxi, ambulance, van, or passenger car.

The vehicle 100 includes a frame or chassis 102 operatively coupled to a first pair of wheels 104 and a second pair wheels 106 that propel the vehicle 100 along a ground surface 108. In the illustrative embodiment, the vehicle is shown as a bi-directional vehicle; however, it should be appreciated that in other examples, the vehicle may be one of any number of vehicles suitable for use with a ramp assembly 114 described below. A first passenger opening 110 is located between the first pair wheels 104 and the second pair of wheels 106, and provides access to a passenger for sitting or standing in the vehicle 100. The passenger opening 110 may be modified to increase the size of the opening 110 to provide access, for example, to a passenger seated in a wheelchair to enter and exit the vehicle 100.

The vehicle 100 may include an original floor 112 (e.g., as provided by the original equipment manufacturer, “OEM”) extending throughout the vehicle 100 to support passengers and other objects traveling in the vehicle 100. As shown in FIG. 1, the vehicle 100 may be further modified to include a false floor 122 and the ramp assembly 114. The ramp assembly provides rolling access of a wheelchair from the ground surface 108 into an interior 116 of the vehicle 100. The ramp assembly 114 may be installed adjacent or within the false floor 122. The false floor is disposed on the OEM floor 112 and serves to define a false floor surface 124 disposed above the ramp assembly 114. The false floor surface 124 may extend over and provide a top cover 125 for the ramp assembly 114, or the top cover 125 may be a separate component that is installed over the ramp assembly and is approximately flush with the false floor surface 124. The false floor surface 124 or top cover 125 may include a sloped floor portion 113 that bridges an elevation difference between the false floor surface 124/top cover 125 and a trailing edge 126 of the ramp platform 120 when the ramp platform 120 is deployed.

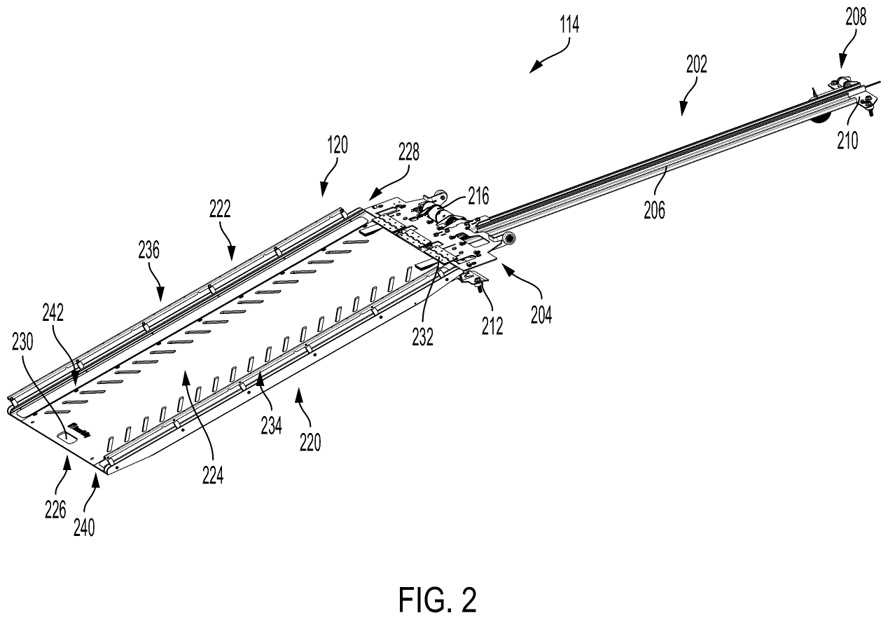

FIG. 2 illustrates a perspective view of one embodiment of the ramp assembly 114 including the ramp platform 120 in a deployed state extending from a guide rail assembly 202 which is disposed beneath the false floor surface 124/top cover 125. The ramp platform 120 is retracted into a cavity defined by or disposed beneath/within the false floor surface 124/top cover 125 and moves along the guide rail assembly 202 when retracted to the stowed position and when extended to the deployed position of FIG. 1.

The ramp platform 120 is hingedly coupled to a chassis 204 which moves along a drive track 206 of the guide rail assembly 202 A first end 208 of the drive track 206 includes a connector assembly 210 fixedly coupled to a portion of the vehicle 100 (e.g., the OEM floor 112, the false floor 122, top cover 125, or other structure). In addition, a floor plate assembly 212 is connects a second end (not shown) of the drive track 206 to the vehicle 100 (e.g., the OEM floor 112, the false floor 122, top cover 125, or other structure). The drive track 206 directs a drive chain or drive belt (not shown) coupled to the chassis 204 for moving the chassis 204 and consequently the ramp platform 120 between its extended (deployed) and retracted (stowed) positions. The chassis 204 supports a drive assembly 216, including for instance a motor, which drives a chain or belt running along the drive track 206, as would be understood by one skilled in the art. However, other configurations for the drive assembly are contemplated, including mounting the motor to the vehicle 100 at a static position. Furthermore, other methods and mechanisms are contemplated for moving the ramp platform 120 between stowed and deployed positions.

The ramp platform 120 includes a first platform side assembly 220 and a second platform side assembly 222 each being coupled to a platform base 224. The platform side assemblies 220 and 222 extend longitudinally along edges of the platform base 224 extending from a first end 226 of the platform base 224 to a second end 228 of the platform base 224. In one embodiment, the first end 226 of the platform base 224 includes a handhold opening 230 to enable an individual to raise end 226 of the ramp platform 120 from the ground surface 108 or lower end 226 to the ground surface 108 and/or to manually move the ramp platform 120 between the stowed and deployed positions. A hinge 232 is coupled between the second end 228 of the platform base 224 and the chassis 204 to allow the ramp platform 120 to pivot downward relative to the chassis 204 in the deployed position to bridge the gap between the ground 108 and sloped floor portion 113. Additionally, each of the first platform side assembly 220 and the second platform side assembly 222 include respectively a first siderail 234 and a second siderail 236.

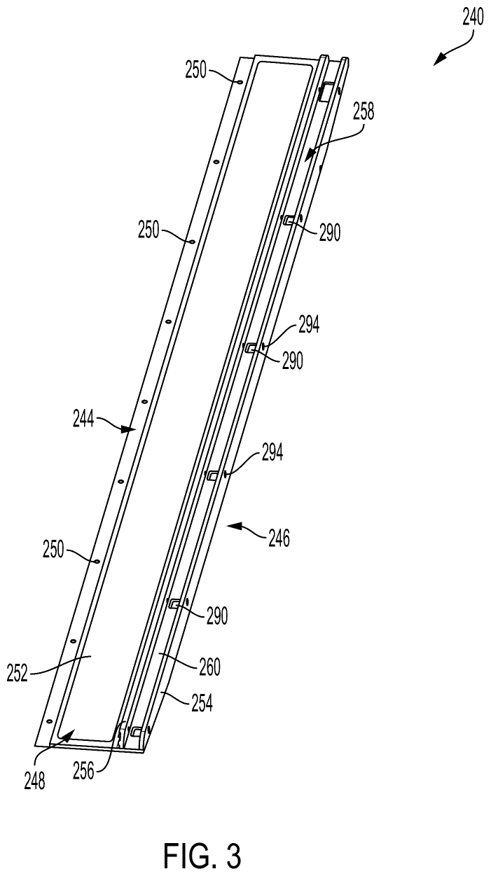

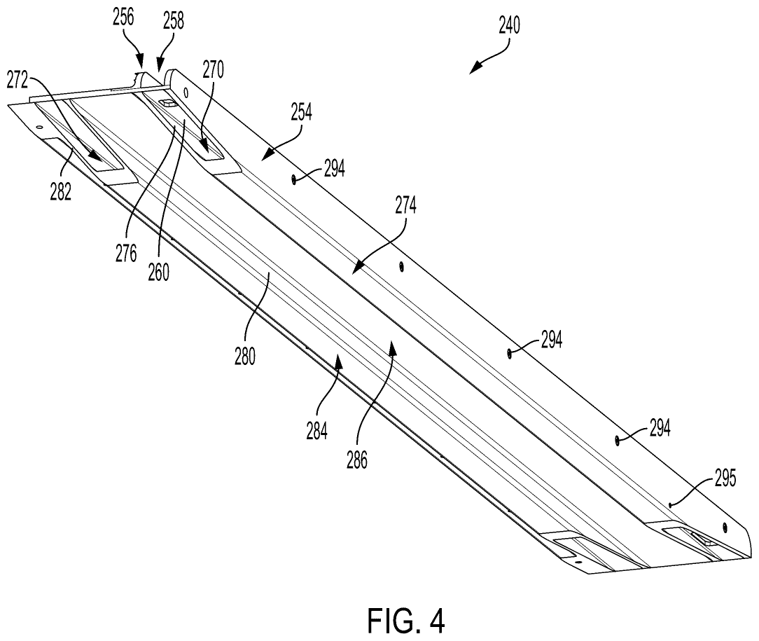

FIG. 3 illustrates a top perspective view of a first side part 240, which is included as a part of the first platform side assembly 220, while FIG. 4 illustrates a bottom perspective view of the first side part 240. A similar second side part 242 is included in the second platform side 222 and is similarly formed as the first side part 240 but as a mirror image of the first side part 240. In one or more embodiments, the side parts 240 and 242 are formed using an extrusion process and thereafter machined to include various features than cannot be provided by an extrusion, such as the lead-in portions 271, 273 and various apertures described below. The side parts 240, 242 may be formed of metal, such as aluminum, plastic, or other material having sufficient strength and being suitable for extrusion and machining. The first and second side parts 240, 242 may be identical/interchangeable with each other for example, by rotating them 180° about an axis normal to their top surface. The side rails 234, 236 may also be mirror images and/or interchangeable. The description of the structure of the first side part 240, therefore, applies to the structure of the second side part 242. Similarly, the description of the first side rail 234 applies to the second side rail 236.

As seen in FIG. 3, the first side part 240 includes one or more of a connector section 244, a rail section 246, and a track section 248 located between the connector section 244 and the rail section 246. Each of the connector section 244, the rail section 246, and the track section 248, extends longitudinally along a length of the first side part 240 and when connected to the platform base 224, extends substantially from the first end 226 to the second end 228 of the platform base 224. The connector section 244 is configured for connection to the platform base 224 and, for that purpose, may include a recessed flange area with a plurality of apertures 250, each of which enables the first side part 240 to be connected to the platform base 224 with connectors (not shown) that extend through the apertures 250 and similarly located apertures (not shown) located in the platform base 224. It is contemplated that other embodiments may use any type of fastener to connect the side parts 240, 242 to the platform base 224, including bolts and nuts, rivets, welds, glue, etc. Once connected, the top surface of the platform base 224 may be approximately flush with the top surface of the track section 248. The track section 248 is substantially planar and is configured to receive a traction strip 252 configured to provide traction to wheels of a wheelchair used by a physically limited individual.

The rail section 246 may include a first sidewall 254 and a second sidewall 256 spaced from the first sidewall 254 to define a slot 258. The slot 258 may include a slot floor 260, whereby the first sidewall 254, the second sidewall 256, and the floor 260 may define a U-shaped slot. The slot 258 receives the first side rail 234 which is stored therein in a collapsed condition when the ramp platform 120 is fully retracted in a stowed position. In one embodiment, the first side rail 234 in the collapsed condition is approximately flush or close thereto with the top of at least one of the sidewalls 254, 254. As the ramp platform 120 moves from the retracted position the to the extended position, the first siderail 234 moves to a raised position to provide a barrier or obstacle to indicate to a user of a wheelchair that sides of the ramp platform are being approached or have been contacted.

FIG. 4 illustrates a bottom perspective view of the first side part 240. which may include one or more support structures that are configured to reinforce the ramp platform 120. The support structures may be an integral or separate component connected to the ramp platform 120, and may take any form that provides sufficient beam strength for supporting the weight of a wheelchair. In one embodiment, the support structures can include an integral first channel 270 and an integral second channel 272. The first channel 270 subtends the slot floor 260 and may be defined by a portion of the first sidewall 254, a first channel bar 274, and a bottom sidewall 276. The first sidewall 254 extends below the slot floor 260 where it may terminate at the longitudinally extending first channel bar 274. More particularly, the first sidewall 254 extends from the top side of the first side part 240 to a bottom side of the first side part 240. The first channel bar 274 may extend generally perpendicular to the first sidewall 254 and may terminates at the bottom sidewall 276. The first sidewall 254, first channel bar 274, bottom sidewall 276, and slot floor 260 define the channel 270, which may be characterized as a box or tube, and form a first support structure providing beam strength to the ramp platform 120. Similar to the first channel 270, the second channel 272 includes a first channel sidewall 280, a second channel sidewall 282, a second channel bar 284, and a portion of the track 248, each of which is connected to provide a box-like or tubular second support structure for the side part 240. Each of the channels 270 and 272 is separated by a predetermined distance and collectively provide a sufficient support structure that allows the ramp platform 224 to bear the weight of a wheelchair. At least the first end 226 of the channels 270, 272, and possibly also the second end 228, includes a lead-in, angled or chamfered portion 271, 273 that allows the bottom surface of the track section 248 and platform base 224 to rest at least closely adjacent the ground 108.

As seen in FIG. 3, the slot floor 260 in combination with the first sidewall 254 and the second sidewall 256 may provide directional stability for the first siderail 234 during movement thereof. The slot floor 260 defines a plurality of floor apertures 290 that at least partially receive and provide clearance for the bottom ends siderail legs 298 and to thereby provide a compact geometry for the siderail 234 in its collapsed state (allowing the apertures 294 and pivot pins 296 to be disposed close to the slot floor, whereby the siderail 234 can sit lower in the slot 258 when collapsed).

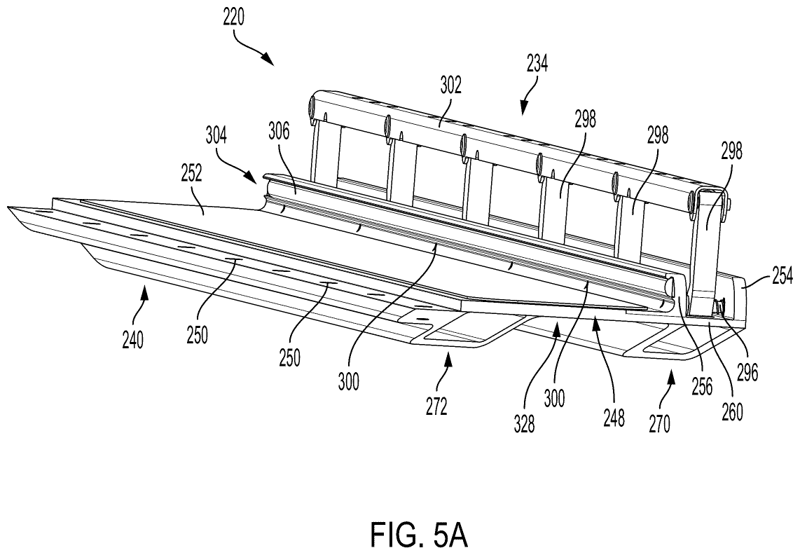

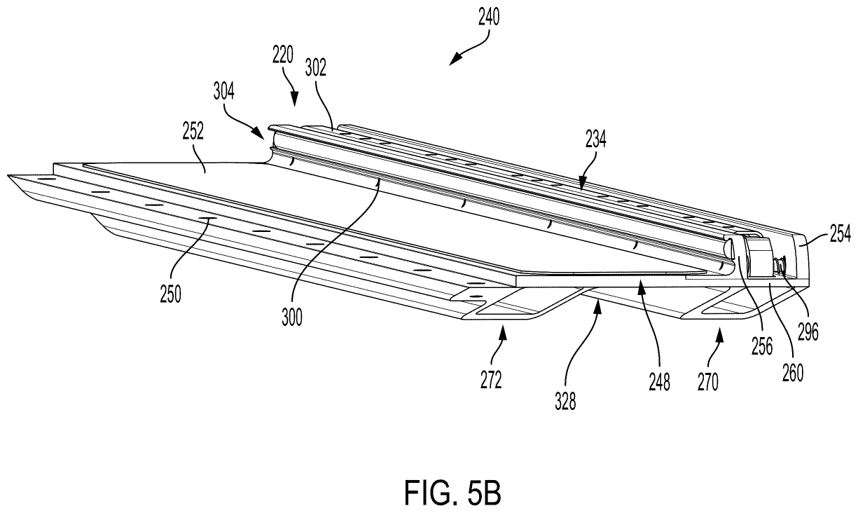

FIG. 5A illustrates the first side part 240 supporting the moveable first siderail 234 in the raised position, while FIG. 5B shows the siderail 234 in the collapsed position. In the collapsed position, the top surface of the moveable first siderail 234 may rest at or below the top edges of sidewalls 254, 256. To support the first siderail 234, the first sidewall 254 includes a plurality of apertures 294 as seen in FIGS. 3 and 4. Pivot pins 296, one of which is illustrated in FIG. 5 extends through the apertures 294, the sidewall 254, and through a plurality of siderail legs 298. The pivot pins 298 may be held by and terminate at apertures 300 (e.g., tapped holes that may be blind holes) located at the sidewall 256. In that respect, the moveable first siderail 234 is supported on both sides-on one side by the first sidewall 254 and on the opposite side by the second sidewall 256—which provides a more structurally sound construction that is less prone to damage as compared to prior art single-side installations. Each of the legs 298 rotatably supports a bar 302 of the first siderail 234. More particularly, each siderail leg 298 may be of equal length and pivotally secured at the bottom end to the first side rail part 220 and at a top end to the bar 320 to define a parallelogram linkage system. During extension of the ramp platform 120, the legs 298 rotate about the pivot pins 296 which raises the bar 302 to an elevated position and which moves the siderail 234 to the raised position. The bar 302 may comprise a channel and/or, as shown, have an inverted U-shape that allows the legs 298 to at least partially nest therein when the moveable siderail 234 is in the stowed position (FIG. 5B)—allowing a lower profile collapsed configuration and an overall thinner ramp assembly 114.

As seen in FIGS. 5A and 5B, the second sidewall 256 includes a longitudinal track 304 which extends along the length of the second sidewall 256. The track 304 may include an upper lip 303 and a lower lip 305, each of which defines an undercut, whereby the track 304 may be configured to receive and to support a light strip 306, either by insertion through an end of the track 304 or by snapping/angling in a direction generally normal to the track 304. The light strip 306, when illuminated, provides illumination to the ramp platform 120, including but not limited to the traction strip 254. In different embodiments the strip light 306 includes incandescent light(s), LED light(s), or combinations of both incandescent light and LED light. In other embodiments, the individual lights are located along the longitudinal track 304.

FIGS. 5A and 5B further illustrates that in one embodiment, each of the first platform side assembly 220 and second platform side assembly 222 includes a modular configuration including separate parts that when combined from a complete modular unit. For instance, the modular configuration for the first platform side assembly 220 includes the first side part 240, the first siderail 234, the traction strip 252, and the light strip 306. In another modular configuration, the first platform side assembly 220 includes the first side part 240 and the first siderail 234 with the traction strip 252 and the light strip 306 omitted or added later as an option. In another modular configuration, the very same components (side part, siderail, and lightstrip) can be assembled to make either the first platform side assembly 220 or the second platform side assembly 222, the only difference being that the siderail is rotated 180° between the two.

A light mounting structure, defined in part by the longitudinal track 304, supporting the illumination devices, in one or more embodiments, is integral to the extrusion profile which has not been seen encountered previously. Lighting strategies for pedestrian/user warning, in one or more embodiments, is in the form of integrated lighting having flashing and/or color indicators. In further embodiments, a warning light located at one or both ends (or along the entire length) of the ramp appears as flashing and/or red to indicate that the stow and deploy cycle is active. A green and/or steady light at one or both ends (or along the entire length) of the ramp indicates a safe ramp use state.

In one or more embodiments, the first platform side assembly 220, the platform base 224, and the second platform side assembly 222 provides the ramp platform 120 with a modular configuration. Collectively, these assemblies define a width of the overall ramp platform 120. In one embodiment, the width dimensions of the side assemblies 220 and 222 remain the same for all ramp platforms and only the platform base 224 changes in width. For instance, if the platform base 224 is formed of a solid aluminum (or other metal) sheet, changing the width of the sheet enables platform bases 224 of different width to use of the same side assemblies. In addition, the side assemblies 220 and 222 eliminate the need for expensive/long lead composite ramp center panels seen on other comparable ramps. In this embodiment, the width of the platform base 224 is the width controlling component of the ramp assembly 114. Use of this modular configuration with the centrally-located guide rail assembly 202 (or other guide rail that is located above or below the ramp platform 120, rather than to the left and right sides as with previous ramps) enables easy and quick creation of new ramps having different widths using all of the same components except for the platform base 224. To fully appreciate the benefits of this modular design, it may be necessary to construct the floor plate assembly 212 in multiple sections so that the components on the first and second ends 320, 326 can be properly aligned with the side assemblies 220, 222, as described below.

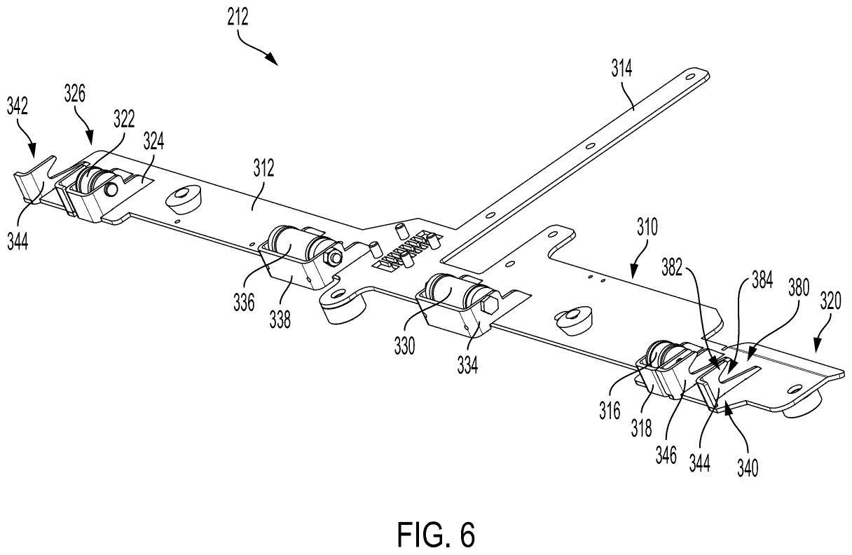

The floor plate assembly 212, further illustrated in FIG. 6, includes a base plate 310 including a main portion 312 and an extended portion 314 extending from the base portion 312. The extended portion 314 is configured to connect to the guide rail assembly 202 and provides coupling support of the drive track 206 to the vehicle 100 (e.g., OEM floor 112, false floor 122, top cover 125, or other structure). The main portion 312 provides rolling support for the ramp platform 120 moving between retracted and extended positions. To provide rolling support for the ramp platform 120, a first side roller 316 is pivotally supported with a roller support 318 located toward a first end 320 of the main portion 312. A second side roller 322 is pivotally supported with a roller support 324 located toward a second end 326 of the main portion 312. As illustrated, the first side roller 316 provides rolling support for the first platform side assembly 220 and the second side roller 322 provides rolling support for the second platform side 222. Each of the first side roller 316 and the second side roller 322 contact an underneath side of the respective platform sides. For instance, first side roller 316 contacts and rollingly supports the first platform side assembly 220 at a longitudinally extending roller track 328, defined along the space 286, located between the first channel 270 and the second channel 272. See FIGS. 5A and 5B. The second platform side 222 is similarly configured with a longitudinally extending roller track.

The floor plate assembly 212 further includes a first center roller 330 pivotally supported by a first center roller support 334 and a second center roller 336 pivotally supported by a second center roller support 338. Each of the first and second center rollers 334 and 336 rollingly support a central portion of the platform base 224. As an alternative to the rollers 316, 322, 330, 336, it is contemplated that low friction supports or gliders may be used, such as those made out of Teflon or similar materials.

The motion of the siderails 234, 236 is activated by end-of-stroke action of a trigger link. More specifically, the trigger link, which is coupled to a siderail (control) link 352, contacts activation structures on the base plate (threshold) 310 as the ramp platform 120 approaches its fully deployed position. Once engaged with the activation structures, the trigger link is pivotably fixed to the activation structure at an engagement point between the trigger link and activation structure. As the ramp platform 120 continues to move toward the fully deployed position, the trigger link pulls the siderail link 352, while possibly pivoting about its engagement point with the activation structures, to deploy the siderails 234, 236 by lever action. The siderail link 352 and/or the trigger link is biased to the collapsed position. In that respect, as the ramp platform 120 is moved to the stowed position, the siderails 234, 236 automatically collapse. The trigger link, engagement point, and activation structure may take any form that permits the described lever action.

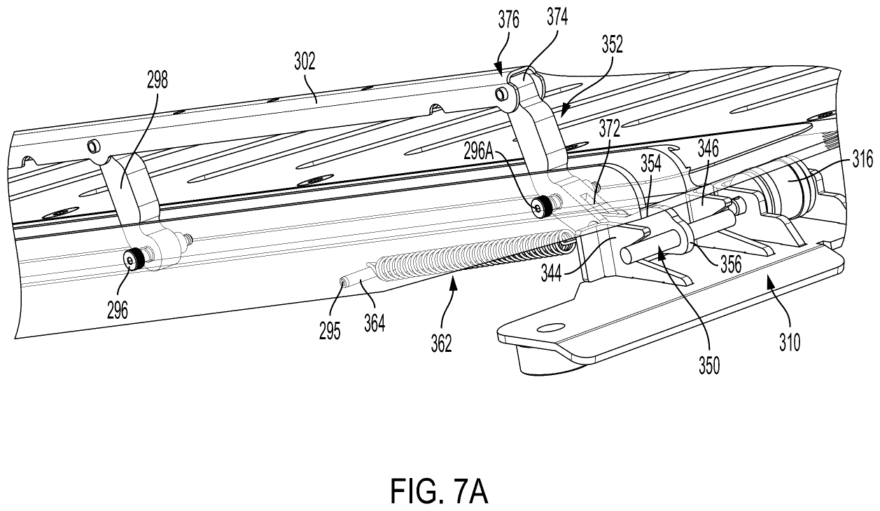

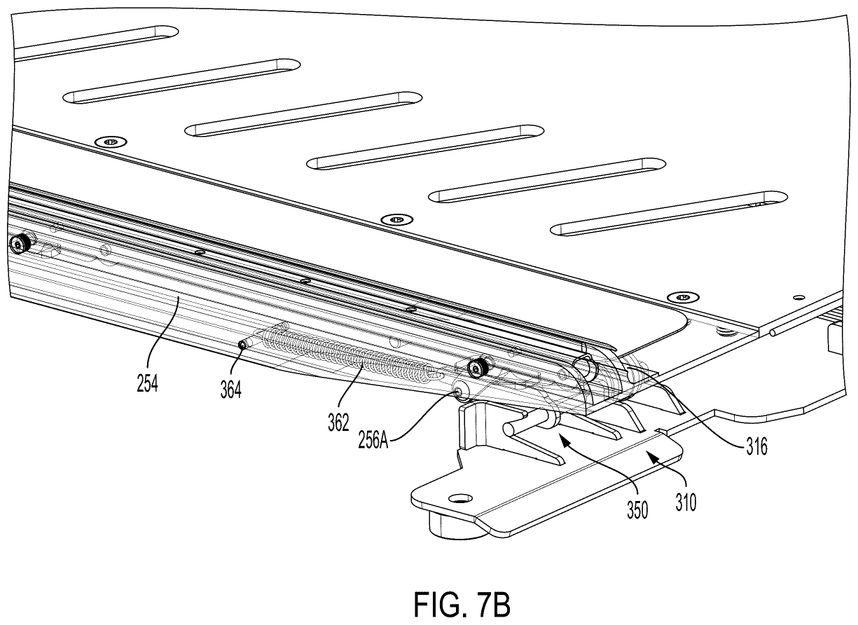

In the disclosed embodiment, as seen in FIGS. 6, 7A, 7B, 8A, and 8B, the base plate 310 includes first catch assembly 340 and a second catch assembly 342 (not shown in FIG. 7), which both serve as activation structures. The first catch assembly 340, like the second catch assembly 342, includes a first hook 344 and a second hook 346 spaced from the first hook 344, both of which extend upwardly from the base plate 310. Each of the first hook 344 and the second hook 346 are substantially aligned with respect to one another to receive opposite ends of a T-bar 350, which serves as the engagement point. The T-bar 350 is disposed on a T-bar link 354, which serves as the trigger link. The T-bar link 354 is pivotally coupled to a side rail link 352.

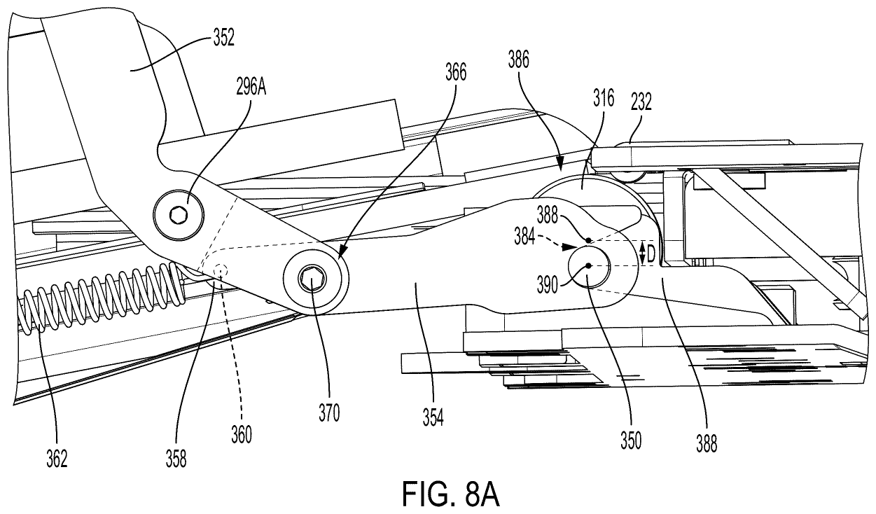

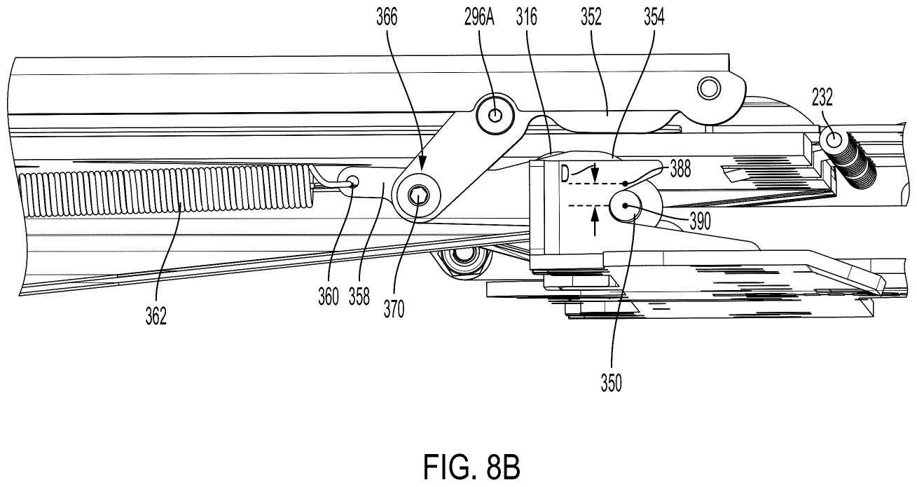

The T-bar link 354 has a first end 356 to which the T-bar 350 is coupled and a second end 358, as illustrated in FIGS. 8A and 8B. The second end 358 of the T-bar link 354 includes an aperture 360 to which a resilient or biasing member 362, e.g. spring 362 (see FIG. 7) is connected. In one embodiment, the spring 362 is an extension spring which includes an equilibrium or biased position when the siderail is in a collapsed condition (FIGS. 7B and 8B). The spring 362 is coupled to the first platform side 220 by a pin 364 inserted in aperture 295. Notably, the “return” spring 362 may be disposed/hidden within the extrusion cavity (i.e., first channel 270) to prevent tampering. Between its first and second ends 356, 358, the T-bar link 354 is pivotally coupled to a first end 366 of a siderail link 352 at a pivot connection 370. To accommodate coupling of the T-bar link 354 to the siderail link 352, a slot 372 located at the first end 366 of the siderail link 352 is configured to receive the second end 358 of the T-bar link 354. Upon actuation of the siderail 234, the T-bar link 354 pivots relative to the siderail link 352 within the slot 372. The siderail link 352 includes a second end 374 pivotally coupled to an end 376 of the bar 302. During actuation of the siderail 234, the bar 302 rotates relative to the siderail link 352 about a pin 296A as seen in FIGS. 7A, 7B, 8A, and 8B.

Initially, the siderail 234 is in a collapsed, i.e., lowered, position and is held in place (biased) within the slot 250 by the spring 362, which pulls T-bar link 354 toward pin 364. T-bar link 354 in turn urges siderail link 352 in a clockwise direction (about pin 296A, as viewed in FIG. 8B), by virtue of being coupled thereto at pivot connection 370. As the ramp platform 120 is deployed, the ramp platform 120 moves toward the baseplate 310, and the T-bar 350, which is coupled to the ramp platform 120 through the siderail linkage 352, moves into contact with the catch assembly 340. The motion of the siderails 234, 236 is then activated by end-of-stroke action of the T-bar link 354 (the trigger link). Once the T-bar 350 is engaged with the catch assembly 340, the T-bar link 354 is pivotably fixed to the catch assembly about an axis 390 of the T-bar 350. As the ramp platform 120 continues to move toward the fully deployed position, the T-bar link pulls a portion of the siderail linkage 352 (against the force of the spring 362), while possibly pivoting about the axis 390 of the T-bar 350, to deploy the siderails 234, 236 by lever action. More particularly, T-bar link 354 pivots siderail link 352 in a counterclockwise direction (about pin 296A, as viewed in FIG. 8A), by virtue of being coupled thereto at pivot connection 370.

To accommodate rotational movement of the legs 298 about the pins 296 during raising and lowering of the siderail, ends 299 of the legs 298 move within the floor apertures 290 as the legs 298 rotate about the pins 296. As seen in FIG. 3, aperture 290A is larger than the other apertures 290 to accommodate the siderail link 352. The larger size of aperture 290A as shown in the embodiment of FIG. 3, permits the siderail link 352 to extend through the aperture 290A such that one end of the siderail link 352 is rotatably coupled to the bar 302 and the other end of the siderail link 352 is rotatably coupled to the T-bar link 354.

When the platform assembly 120 returns to the stowed position, the stored spring tension releases, the spring 362 returns to its equilibrium position, and causes the siderail 234 to return to its lowered position. Consequently, the motion of the side rails is activated by end-of-stroke action of the T-bar, or other triggering link contacting static activation hooks on the threshold or at the point of moving the platform into contact with the ground surface. The return springs are hidden within the extrusion cavity and out of the way to reduce or prevent tampering in a ride share environment.

Notably, the angle of the ramp platform 120 relative to ground 108 in its deployed position will vary from one loading/unloading location to another depending upon ground elevation and contours. Ideally, however, the siderail 234, 236 height will remain relatively constant regardless of the deployed ramp angle. To fix the deployed siderail 234, 236 height within a small or acceptable range, a distance D between the rotational axis 388 of rollers 316, 322, 330, 336 and the axis 390 of T-bar 350 (about which T-bar link 354 can pivot once engaged with catches 340, 342) is minimized. With this geometry, the position of T-bar link 354 (including pivot points 370, 390) is generally fixed relative to the ramp platform 120 when the ramp platform 120 is in the deployed position, regardless of the angle of the ramp platform 120 relative to ground. In some embodiments, the distance D is less than the radius of one or more of the rollers 316, 322, 330, 336.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A ramp assembly to accommodate a wheelchair passenger to enter or exit a motorized vehicle, the ramp assembly comprising a ramp platform defined by:
a platform base having a first side and a second side;
a first platform side assembly removably coupled to the first side; and,
a second platform side assembly removably coupled to the second side.

2. The ramp assembly of claim 1 wherein: the first platform side assembly includes a first track section located on a top side of the first platform side assembly and a first roller track located on a bottom side of the first platform side assembly beneath the first track section; and the second platform side assembly including a second track section located on a top side of the second platform side assembly and a second roller track located on a bottom side of the first platform side assembly beneath the second track section.

3. The ramp assembly of claim 2 wherein the first platform side assembly includes at least one support structure to provide a beam strength to the ramp assembly.

4. The ramp assembly of claim 3 wherein the at least one support structure defines a tube.

5. The ramp assembly of claim 2 wherein the first platform side assembly includes a first bottom support structure and a second bottom support structure spaced from the first bottom support structure, wherein the first roller track is located between the first bottom support structure and the second bottom support structure.

6. The ramp assembly of claim 5 wherein one or more of the first bottom support structure and the second bottom support structure defines a channel.

7. The ramp assembly of claim 5 wherein the first bottom support structure includes a first sidewall having a bottom portion and a top portion, wherein the first sidewall extends from the bottom portion beneath the first track section and extends to the top portion above the first track section.

8. The ramp assembly of claim 7 wherein the top portion of the first sidewall defines a first slot with a first top sidewall, wherein the first slot is configured to receive a first siderail.

9. The ramp assembly of claim 8 wherein the first siderail includes a first bar rotatably supported by a plurality of first legs, wherein each of the plurality of first the legs is rotatably coupled to the first sidewall and the first siderail includes a lowered position in the first slot and a raised position extended from the first slot.

10. The ramp assembly of claim 9 wherein the first bar comprises a channel and wherein at least one of the first legs nests within the channel when the first siderail is in the lowered position.

11. The ramp assembly of claim 10 wherein the first slot is defined by a pair of sidewalls and wherein the plurality of leg links are received between and pivotably secured to the pair of sidewalls.

12. The ramp assembly of claim 11, wherein a top of the first siderail is disposed approximately at or below a top edge of the pair of sidewalls.

13. The ramp assembly of claim 1 wherein the first platform side assembly and the second platform side assembly include respectively an extruded first side part and an extruded second side part.

14. The ramp assembly of claim 13 wherein the extruded first side part and extruded second side part are interchangeable.

15. The ramp assembly of claim 1 wherein the first platform side assembly and the second side assembly include respectively a first siderail assembly and a second siderail assembly.

16. The ramp assembly of claim 15 wherein the first siderail assembly and second siderail assembly are interchangeable.

17. The ramp assembly of any claim 1 further comprising a chassis pivotally coupled to a trailing edge of the ramp platform and movable along a length of a guide rail assembly.

18. The ramp assembly of claim 17 wherein the guide rail assembly is disposed between a left side and a right side of the ramp platform.

19. The ramp assembly of claim 17 wherein the guide rail assembly is disposed below the ramp platform.

20. A first ramp assembly and a second ramp assembly of claim 1, wherein: the platform base of the first ramp assembly has a different width than the platform base of the second ramp assembly; and a first set of the first and second platform side assemblies are interchangeable with a second set of the first and second platform side assemblies.
